(19) United States
(12) Patent Application Publication
(10) Pub. No.: US 2025/0080009 A1
(43) Pub. Date: Mar. 6, 2025

(54) INVERTER UNIT

(71) Applicant: Robert Bosch GmbH, Stuttgart (DE)

(72) Inventors: Jonathan Winkler, Sonnenbuehl (DE); Karl Oberdieck, Stuttgart (DE); Manuel Riefer, Reutlingen (DE); Sebastian Strache, Wannweil (DE)

(21) Appl. No.: 18/816,078

(22) Filed: Aug. 27, 2024

(30) Foreign Application Priority Data
Sep. 4, 2023 (DE) 10 2023 208 477.5

(51) Int. Cl. H02M 7/537

(52) U.S. Cl. CPC H02M 7/537

(57) ABSTRACT

An inverter unit. The inverter unit includes: a switch; an intermediate circuit; and a component. The inverter unit is configured to switch the switch on the basis of a predetermined switching sequence in order to drain the intermediate circuit. The predetermined switching sequence is configured to generate a current drop in the intermediate circuit at a substantially constant change in order to introduce a thermal energy, generated by a short circuit, into the inverter unit in order to determine an aging of the component.

### CROSS REFERENCE

The present application claims the benefit under 35 U.S.C. § 119 of German Patent Application No. DE 10 2023 208 477.5 filed on Sep. 4, 2023, which is expressly incorporated herein by reference in its entirety.

### FIELD

The present invention relates to an inverter unit and to a vehicle.

### BACKGROUND INFORMATION

Currently, a variety of different solutions of inverter unit and method exist for separating the battery protection in electrically driven vehicles. As a result of the increasing number of electrically operated vehicles and increased effectiveness, the need for innovative and robust inverter units increases continuously.

The continuous weight reduction in the vehicle sector for diminishing consumption as well as the increasing competition create cost pressure so that more cost-effective and more efficient components for vehicles are more in demand.

### SUMMARY

An inverter unit according to the present invention may be advantageous over conventional ones in that the energy present in the intermediate circuit, which should be discharged, is used to determine an aging of the inverter unit, in particular of a component of the inverter unit. Due to the constant discharge, the inverter unit can generate a specific temperature increase and can compare this temperature increase to previous temperature increases in order thus to be able to determine the aging of the thermal path. It is advantageous in this respect that the introduced thermal energy can be deduced on the basis of the precise knowledge of the converted energy from the intermediate circuit.

According to an example embodiment of the present invention, this may be achieved by an inverter unit including a switch, an intermediate circuit, and a component. The inverter unit is configured to switch the switch on the basis of a predetermined switching sequence in order to drain the intermediate circuit, wherein the predetermined switching sequence is configured to generate a current drop in the intermediate circuit at a substantially constant change in order to introduce thermal energy, generated by a short circuit, into the inverter unit in order to determine an aging of the component.

In other words, the switch forms a short circuit with the intermediate circuit in order thus to generate thermal energy. In particular, the short-circuit is formed in such a way that a plurality of short-circuits can introduce a constant heat flow into the inverter unit by opening and closing the switch. The current drop in the intermediate circuit due to the switching of the short circuits by means of the switch can be used to quantify the amount of heat introduced into the inverter unit. By means of the introduced heat, a heating of a component of the inverter unit can be calculated. Further preferably, a comparison between the heating of the component of the inverter unit at a first time and a heating of the component at a second time with an identical generated thermal energy can be used to determine a difference between the heating at the first time and at the second time in order to be able to ascertain the aging of the component on the basis of this difference. In a plurality of discharges by means of the intermediate circuit by means of the short-circuits and the correspondingly introduced thermal energy, an aging of the component of the inverter unit can thus be tracked. In this context, the substantially constant change can in particular be a current drop change of +/−50%. Further preferably, the predetermined switching sequence is designed such that the switch is switched to form the short circuit until the intermediate circuit is substantially fully discharged so that a safe state of the inverter unit can be achieved. The component of the inverter unit can likewise comprise the switch. Further preferably, at least a portion of the switch can be heated by means of the predetermined switching sequence and/or the short circuit.

Preferred developments of the present invention are disclosed herein.

According to an example embodiment of the present invention, preferably, the predetermined switching sequence is configured to generate a short circuit in the inverter unit at least temporarily.

An advantage of this example embodiment is that the inverter unit can comprise a plurality of switches or the like, wherein the inverter unit or the predetermined switching sequence is configured such that the short-circuit can be generated by means of at least one switch, wherein all further switches can be switched accordingly in order thus to be able to discharge the intermediate circuit by means of a constant change.

According of an example embodiment of the present invention, further preferably, the short circuit is a high-impedance half-bridge short circuit.

An advantage of this example embodiment is that damage to the inverter unit or to the other component due to inadvertently switching the switch to conductive can be avoided.

According to an example embodiment of the present invention, preferably, the inverter unit is configured to adjust the predetermined switching sequence when a voltage on the switch reaches a reference voltage, in order to resolve the short circuit.

An advantage of this example embodiment is that the switch can be opened again when a limit voltage is reached as the target voltage. Thus, both the closing time of the switch and the opening time of the switch can be defined in the predetermined switching sequence and can be adjusted on the basis of the reference voltage or the measured voltage on the switch.

According to an example embodiment of the present invention, preferably, the inverter unit is configured to generate a first current drop in the intermediate circuit at a first time and a second current drop in the intermediate circuit at a second time, wherein the inverter unit is configured to record the temperature of the component, wherein the inverter unit is configured to record a first temperature profile of the component for the first current drop and a second temperature profile of the component for the second current drop, wherein the inverter unit is configured to determine, on the basis of a comparison between the first temperature profile and the second temperature profile, the aging of the component.

An advantage of this example embodiment is that by comparing the temperature profiles, the aging of the component can be deduced. Preferably, a plurality of temperature profiles is generated over the operating duration of the inverter unit so that the aging of the component can be determined continuously over the operating duration. The aging can in particular be detected by the conductivity of the inverter unit and/or of the components thereof decreasing continuously over the operating duration.

According to an example embodiment of the present invention, further preferably, the predetermined switching sequence is configured to set the switch to a first state, wherein a gate voltage is equal to or less than a plateau voltage in the first state.

An advantage of this example embodiment is that, with the existing voltages, the switch will not conduct at low impedance, which can lead to a high short-circuit current, which could possibly damage components of the inverter unit as well as other components. Thus, despite the switching of the short circuit by means of the switch, the inverter unit remains in a safe state.

According to an example embodiment of the present invention, further preferably, the inverter unit is configured to determine and/or adjust a switching duration of the switch in the predetermined switching sequence. An advantage of this embodiment is that a switching duration of the switch can be determined or adjusted for each switching cycle in the predetermined switching sequence in order thus to be able to generate the preferably constant current drop in the intermediate circuit. The switching duration may depend on a variety of factors that should be taken into account in the determination and/or adjustment of the switching duration.

According to an example embodiment of the present invention, further preferably, the inverter unit is configured to adjust the switching duration depending on a stored energy in the intermediate circuit.

An advantage of this example embodiment is that the intermediate circuit may have different charge states and the switching duration or the predetermined switching sequence can be adjusted on the basis of the energy in the intermediate circuit in order to be able to achieve the constant change in the current drop.

According to an example embodiment of the present invention, further preferably, the inverter unit is configured to ascertain an amount of energy for introduction into at least a portion of the inverter unit depending on the switching duration and the stored energy.

An advantage of this example embodiment is that an amount of energy can be determined for each cycle of switching by means of the switch, and the resulting temperature at the switch can thus be calculated. In particular, the energy in the intermediate circuit can be determined at the beginning of the discharging or of the current drop in the intermediate circuit. The determined energy of the discharge time of the switching frequency and the power dissipation can be used to determine an array with the target energies per switching operation and the intermediate circuit voltage during each switching operation in the predetermined switching sequence. This energy array can be folded with the thermal target impedance in order thus to be able to ascertain the temperature during each switching operation. Based on the dependence of the gate voltage on the switch-on time, it is preferred to use the temperature, the intermediate circuit voltage, and the temperature dependence of the threshold voltage, that of the K-value to calculate the current for the current drop in the intermediate circuit. Further preferably, the following formula can be used:

I_Dsat=K/2*(V_GS−V_Th)²

Preferably, I_Dsat is at least a portion of the current drop, K is the K-value, V_GS is the voltage at the gate, and V Th is the threshold voltage.

On the basis of the current, the energy value per switching cycle can be ascertained depending on the switch-on duration by the integration with the voltage. As a result, by comparing the real energy with the target value for each cycle, the switch-on time can preferably be ascertained.

According to an example embodiment of the present invention, preferably, the inverter unit is configured to adjust the predetermined switching sequence on the basis of the ascertained amount of energy such that the intermediate circuit discharges at the constant change.

An advantage of this example embodiment is that, on the basis of the ascertained amount of energy per switching cycle, the constant change in the current drop can be quantified further and the thermal energy can thus be ascertained precisely.

According to an example embodiment of the present invention, further preferably, the constant change has a linear profile and/or a logarithmic profile.

An advantage of this example embodiment is that the energy can also be discharged from the intermediate circuit with a logarithmic increase in order thus to be able to better determine the aging of the component.

According to an example embodiment of the present invention, preferably, the inverter unit is configured to determine a voltage change in the intermediate circuit, wherein the inverter unit is configured to adjust the ascertained amount of energy on the basis of the voltage change.

An advantage of this example embodiment is that the voltage change between two or more switching cycles in the predetermined switching sequence can be ascertained and the target energy can thus be compared to the real energy in order to adjust the switching sequence accordingly in order thus to be able to correct the current drop.

According to an example embodiment of the present invention, preferably, the inverter unit comprises a comparator, wherein the inverter unit is configured to adjust the current drop in the intermediate circuit by means of the comparator.

An advantage of this example embodiment is that the current drop for a switching cycle in the predetermined switching sequence can be quantified and the current drop in the intermediate circuit can thus be further linearized. In particular, it is possible to switch from a controlled operation of the inverter unit to a regulated operation since the inverter unit is capable of using the comparator to quantify the current drop accordingly.

According to an example embodiment of the present invention, preferably, the inverter unit is configured to determine a temperature of the component, wherein the inverter unit is configured to form a difference between the thermal energy generated by means of the short circuit and a heating of the component, wherein the inverter unit is configured to determine the aging of the component on the basis of the difference.

An advantage of this example embodiment is that, over the operating duration of the inverter unit, the difference increases continuously. Further preferably, the difference over the period of the operating duration of the inverter unit can be compared to individual draining or discharging processes of the intermediate circuit in order thus to be able to deduce the aging of the component.

A further aspect of the present invention relates to a vehicle comprising an inverter unit of the present invention as described above and below.

### BRIEF DESCRIPTION OF THE DRAWINGS

Exemplary embodiments of the present invention are described in detail below with reference to the figures.

FIG. 1 shows an inverter unit according to one example embodiment of the present invention.

FIG. 2 shows a diagram illustrating the functioning of the inverter unit according to one example embodiment of the present invention.

FIG. 3 shows a diagram illustrating the functioning of the inverter unit according to one example embodiment of the present invention.

FIG. 4 shows a circuit diagram illustrating the functioning of the inverter unit according to one example embodiment of the present invention.

FIG. 5 shows a vehicle according to an example embodiment of the present invention.

### DETAILED DESCRIPTION OF EXAMPLE EMBODIMENTS

Preferably, all identical components, units, and/or elements are provided with the same reference signs in all figures.

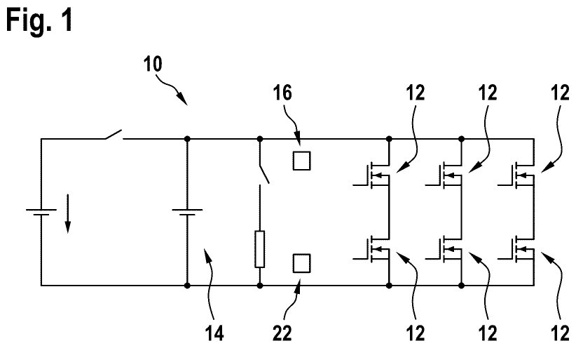

FIG. 1 shows an inverter unit 10 according to one embodiment. The inverter unit 10 comprises a switch 12, an intermediate circuit 14, and a component 16. The inverter unit 10 is configured to switch the switch 12 on the basis of a predetermined switching sequence in order to drain the intermediate circuit 14. Further preferably, the predetermined switching sequence is configured to generate a current drop in the intermediate circuit 14 at a substantially constant change in order to introduce a thermal energy, generated by a short circuit, into the inverter unit 10 in order to determine an aging of the component 16. Further preferably, the inverter unit 10 may comprise a plurality of switches 12. Further preferably, the inverter unit 10 comprises a comparator 22.

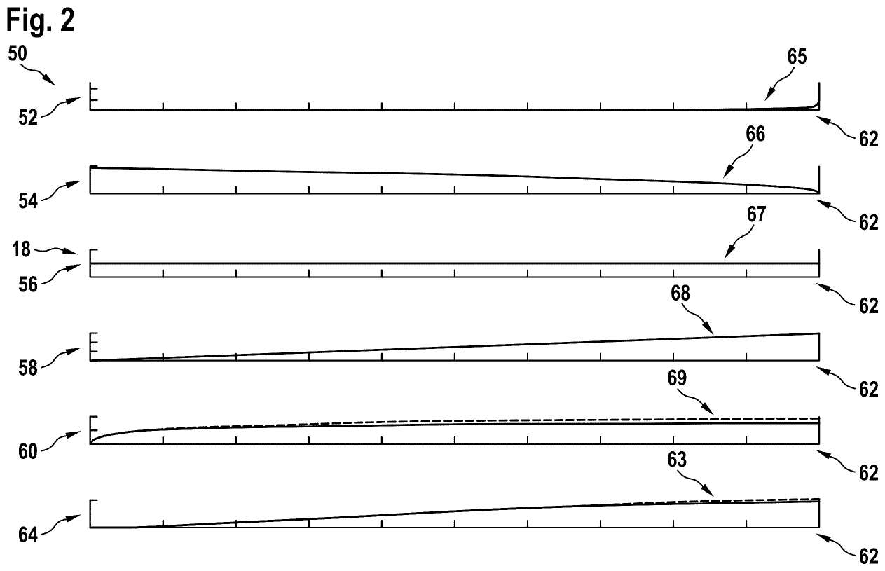

FIG. 2 shows a diagram 50 illustrating the functioning of the inverter unit 10 according to one embodiment. The diagram 50 has a first sub-axis 52, which indicates the current at the switch 12. The second sub-axis 54 indicates the voltage at the switch 12. The third sub-axis 56 indicates the power. The fourth axis 58 indicates the electric field strength. The fifth sub-axis 60 indicates the temperature. The sixth sub-axis 64 indicates the measured temperature. In addition, the diagram 50 has a time axis 62 for each sub-axis. Further preferably, FIG. 2 shows the profile of the measured temperature 63. Further preferably, FIG. 2 shows a profile of the calculated temperature 69.

Further preferably, FIG. 2 shows a profile of the electric field strength 68. Further preferably, FIG. 2 shows a profile of the power 67. The profile of the power 67 is linear in FIG. 2 so that the linear profile 18 is realized. Further preferably, FIG. 2 shows a profile of the voltage 66. Further preferably, a profile of the power 65 is plotted in FIG. 2.

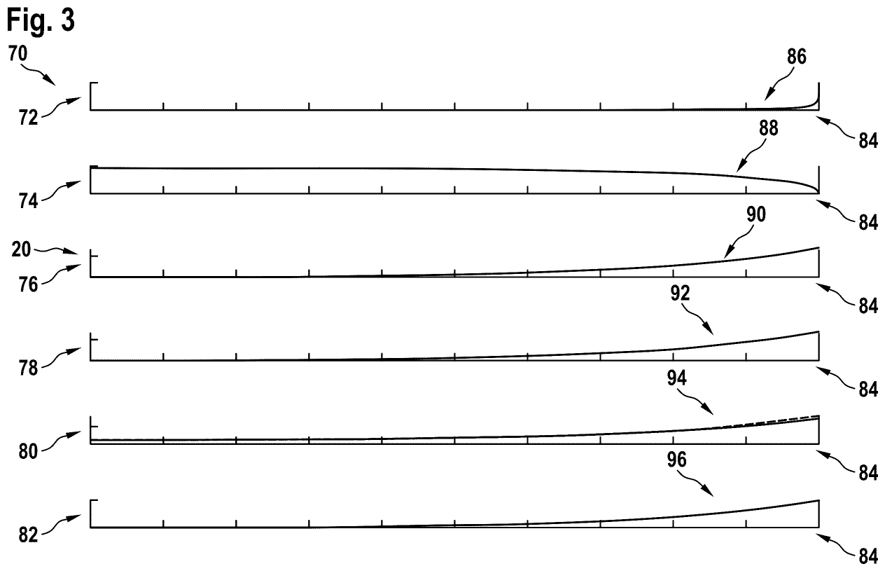

FIG. 3 shows a second diagram 70 illustrating the functioning of the inverter unit 10 according to one embodiment. The second diagram 70 has a first sub-axis 72, which indicates the current. Further preferably, the second diagram 70 has a second sub-axis 74, which indicates the voltage. Further preferably, the second diagram 70 has a third sub-axis 76, which indicates the power. Further preferably, the second diagram 70 has a fourth sub-axis 78, which indicates the electric field strength. Further preferably, the second diagram 70 shows a fifth sub-axis 80, which indicates the theoretical temperature. Further preferably, the second diagram 70 has a sixth sub-axis 82, which represents the measured temperature. All sub-axes of the second diagram 70 have a time axis 84. FIG. 3 shows a profile 86 of the current. Further preferably, a profile 88 of the voltage is shown. Further preferably, a profile 90 of the power flowing out of the intermediate circuit 14 is shown. The profile of the power 90 increases logarithmically so that this represents a logarithmic profile 20. Further preferably, FIG. 3 shows a profile 92 of the electric field strength. Further preferably, FIG. 3 shows the profile 94 of the theoretical temperature. Further preferably, FIG. 3 shows the measured temperature 96.

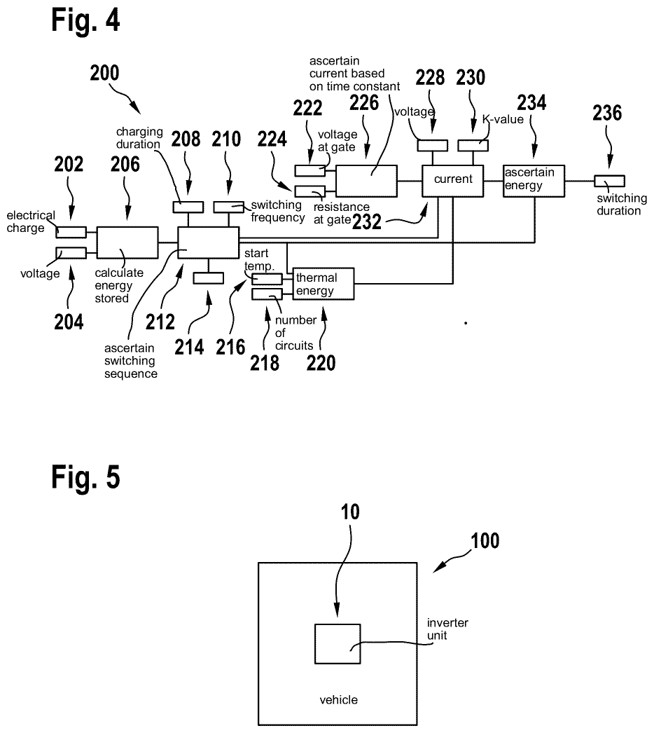

FIG. 4 shows a circuit diagram 200 illustrating the functioning of the inverter unit 10. The energy stored in the intermediate circuit 14 can be calculated 206. The calculation 206 is based on the electrical charge 202 and the voltage 204. The switching sequence 212 can be ascertained on the basis of the calculated 206 stored energy of the intermediate circuit 14. Inputs of the switching sequence calculation 212 are the charging duration 208, the switching frequency 210 of the switch 12, and the power dissipation 2014. Further preferably, the temperature can be quantified when ascertaining 212 of the switching sequence 220. The temperature ascertainment 220 is based on the start temperature 216 of the intermediate circuit 14 and the number 218 of the circuits. On the basis of the ascertainment 212 of the switching sequence and the thermal energy 220, the current can be estimated 232. Current estimation 233 is based in particular on the voltage 228 and the K-value 230. Further preferably, the ascertainment of the current 232 is based on the time constant 226, which includes the voltage at the gate 222 and the resistance at the gate 224. Further preferably, the energy 234 can be ascertained on the basis of the switching sequence ascertainment 212 and the current 232. The switching duration 236 of a switching cycle of the switch 12 for the constant current drop can be ascertained on the basis of the ascertainment of the energy 234.

FIG. 5 shows a vehicle 100 comprising an inverter unit 10, as described above and below.

What is claimed is:

1. An inverter unit, comprising:
a switch;
an intermediate circuit; and
a component;
wherein the inverter unit is configured to switch the switch based on a predetermined switching sequence in order to drain the intermediate circuit; and
wherein the predetermined switching sequence is configured to generate a current drop in the intermediate circuit at a substantially constant change in order to introduce a thermal energy, generated by a short circuit, into the inverter unit in order to determine an aging of the component.

2. The inverter unit according to claim 1, wherein the predetermined switching sequence is configured to generate a short circuit in the inverter unit at least temporarily.

3. The inverter unit according to claim 1, wherein the inverter unit is configured to adjust the predetermined switching sequence when a voltage on the switch reaches a reference voltage, in order to resolve the short circuit.

4. The inverter unit according to claim 1, wherein the inverter unit is configured to generate a first current drop in the intermediate circuit at a first time and a second current drop in the intermediate circuit at a second time, wherein the inverter unit is configured to record a temperature of the component, wherein the inverter unit is configured to record a first temperature profile of the component for the first current drop and a second temperature profile of the component for the second current drop, wherein the inverter unit is configured to determine, based on a comparison between the first temperature profile and the second temperature profile, the aging of the component.

5. The inverter unit according to claim 1, wherein the predetermined switching sequence is configured to set the switch to a first state, wherein a gate voltage is equal to and/or less than a plateau voltage in the first state.

6. The inverter unit according to claim 1, wherein the inverter unit is configured to determine and/or adjust a switching duration of the switch in the predetermined switching sequence.

7. The inverter unit according to claim 6, wherein the inverter unit is configured to adjust the switching duration depending on a stored energy in the intermediate circuit.

8. The inverter unit according to claim 7, wherein the inverter unit is configured to ascertain an amount of energy for introduction into at least a portion of the inverter unit depending on the switching duration and the stored energy.

9. The inverter unit according to claim 8, wherein the inverter unit is configured to adjust the predetermined switching sequence based on the ascertained amount of energy such that the intermediate circuit discharges at a constant change.

10. The inverter unit according to claim 9, wherein the constant change has a linear profile and/or a logarithmic profile.

11. The inverter unit according to claim 9, wherein the inverter unit is configured to determine a voltage change in the intermediate circuit, wherein the inverter unit is configured to adjust the ascertained amount of energy based on the voltage change.

12. The inverter unit according to claim 9, wherein the inverter unit further comprises a comparator, wherein the inverter unit is configured to adjust the current drop in the intermediate circuit using the comparator.

13. The inverter unit according to claim 1, wherein the inverter unit is configured to determine a temperature of the component, wherein the inverter unit is configured to form a difference between the thermal energy generated by the short circuit and a heating of the component, wherein the inverter unit is configured to determine the aging of the component based the difference.

14. A vehicle, comprising:
an inverter unit, including:
a switch,
an intermediate circuit, and
a component,
wherein the inverter unit is configured to switch the switch based on a predetermined switching sequence in order to drain the intermediate circuit, and
wherein the predetermined switching sequence is configured to generate a current drop in the intermediate circuit at a substantially constant change in order to introduce a thermal energy, generated by a short circuit, into the inverter unit in order to determine an aging of the component.
